(19) United States
(12) Patent Application Publication
(10) Pub. No.: US 2015/0008088 A1
(43) Pub. Date: Jan. 8, 2015

(54) TORQUE LIMITER

(71) Applicant: Foxlink Image Technology Co., Ltd., New Taipei City (TW)

(72) Inventor: Ming Wei Lin, New Taipei City (TW)

(21) Appl. No.: 13/936,810

(22) Filed: Jul. 8, 2013

(51) Int. Cl. F16D 7/02

(52) U.S. Cl. CPC F16D 7/022
USPC 192/56.2

(57) ABSTRACT

A torque limiter includes a driving part defining a receiving chamber, an axle part apart inserted in the receiving chamber, and an elastic module including first and second elastic parts frictionally coupled to an outer circumference of the axle part. An inner sidewall of the receiving chamber is radially concaved outward to form two blocking grooves. The first elastic part has one end designed with a first blocking portion and the other end designated as a first end portion. The second elastic part has one end designed with a second blocking portion and the other end designated as a second end portion resisting against the first end portion. The blocking portions are located in the blocking grooves respectively. When the driving part is rotated clockwise/counterclockwise, a torque is produced by friction sliding between the first/second elastic part and the axle part.

### BACKGROUND OF THE INVENTION

1. Field of the Invention

The present invention relates to a limiter, and more particularly to a torque limiter.

2. The Related Art

A torque limiter is an automatic device that protects mechanical equipment, or its work, from damage by mechanical overload. So, the torque limiter is also known as an overload clutch. When the mechanical overload occurs, the torque limiter protects the mechanical equipment by friction sliding. The action of the torque limiter is especially useful to limit any damage due to crash stops and jams.

FIGS. 1 and 2 illustrate one example of a conventional torque limiter. The torque limiter includes a fixed axle 10′, a driving axle 20′ rotatably coupled to the fixed axle 10′, and a torsional spring 30′ having two end portions 31′. The driving axle 20′ has one end thereof designed with a sleeve 21′. The torsional spring 30′ is inserted in the sleeve 21′ and coaxial with the driving axle 20′ and the fixed axle 10′. One end portion 31′ of the torsional spring 30′ is fixed to one end of the fixed axle 10′.

When the driving axle 20′ is rotated towards one direction relative to the fixed axle 10′, a torque is produced by friction sliding between the inside diameter of the torsional spring 30′ and the sleeve 21′ of the driving axle 20′. However, because the torsional spring 30′ has one end portion 31′ fixed to the fixed axle 10′, the driving axle 20′ cannot be rotated towards the other opposite direction relative to the fixed axle 10′ on account of the characteristics of the torsional spring 30′. As a result, the action of the torque limiter protecting the mechanical equipment is achieved only by a single direction rotation of the driving axle 20′.

FIGS. 3 and 4 illustrate another example of a conventional torque limiter. The torque limiter includes a housing 40′, an axle part 60′ and a torsional spring 50′ frictionally coupled to an outer circumference of the axle part 60′. The axle part 60′ coupled with the torsional spring 50′ is inserted in the housing 40′. The housing 40′ includes catch portions 41′ and 42′ that are engaged with end portions 51′ and 52′ of the torsional spring 50′ respectively.

When the axle part 60′ together with the torsional spring 50′ is rotated clockwise relative to the housing 40′, the end portion 51′ of the torsional spring 50′ resists against and is blocked by the catch portion 41′ of the housing 40′. As a result, the torsional spring 50′ stops rotating relative to the housing 40′, but the axle part 60′ still keeps rotating relative to the housing 40′, so a torque is produced by friction sliding between the inside diameter of the torsional spring 50′ and the outer circumference of the axle part 60′. Similarly, when the axle part 60′ together with the torsional spring 50′ is rotated counterclockwise relative to the housing 40′, the end portion 52′ of the torsional spring 50′ resists against and is blocked by the catch portion 42′ of the housing 40′. As a result, the torsional spring 50′ stops rotating relative to the housing 40′, but the axle part 60′ still keeps rotating relative to the housing 40′, so a torque is produced by friction sliding between the inside diameter of the torsional spring 50′ and the outer circumference of the axle part 60′.

In the structure described above, although there is no limit to the rotation directions, the torques are the same from two opposite rotation directions of the torque limiter.

### SUMMARY OF THE INVENTION

An object of the present invention is to provide a torque limiter which includes a driving part, a fastening module and an elastic module. The driving part defines a receiving chamber extending vertically to penetrate through a top face of the driving part. An inner sidewall of the receiving chamber is radially concaved outward to form at least two blocking grooves. The fastening module includes an axle part inserted downward in the receiving chamber of the driving part. An outer circumference of the axle part is spaced from the inner sidewall of the receiving chamber to form a cylindrical clearance therebetween. The driving part is rotatable relative to the fastening module. The elastic module includes a first elastic part and a second elastic part which are disposed in the clearance and frictionally coupled to the outer circumference of the axle part. The first elastic part has one distal end thereof protrude outward to form a first blocking portion and the other distal end thereof designated as a first end portion. The second elastic part has one distal end thereof protrude outward to form a second blocking portion and the other distal end thereof designated as a second end portion. The first end portion resists against the second end portion, and the first blocking portion and the second blocking portion are located in the blocking grooves of the driving part respectively.

In use, when the driving part is rotated clockwise relative to the fastening module, an inner sidewall of one blocking groove pushes against the first blocking portion to make the first elastic part rotate clockwise relative to the axle part and further drive the second elastic part to rotate clockwise by way of the first end portion pushing against the second end portion, so that produces a torque by friction sliding mainly between the first elastic part and the axle part; when the driving part is rotated counterclockwise relative to the fastening module, an inner sidewall of another blocking groove pushes against the second blocking portion to make the second elastic part rotate counterclockwise relative to the axle part and further drive the first elastic part to rotate counterclockwise by way of the second end portion pushing against the first end portion, so that produces a torque by friction sliding mainly between the second elastic part and the axle part.

As described above, the torque limiter in this invention utilizes the elastic module (namely the two elastic parts) and the cooperation design of the blocking grooves and the blocking portions, to achieve the rotations in different directions and further realize different torques according to the rotations in the different directions and the specifications of the elastic parts. So the torque limiter both is no limit to the rotation directions and can realize different torques with the different directions of rotations and changeable specifications of the elastic parts.

### BRIEF DESCRIPTION OF THE DRAWINGS

The present invention will be apparent to those skilled in the art by reading the following description, with reference to the attached drawings, in which:

FIG. 1 and FIG. 2 are perspective views illustrating one example of a conventional torque limiter;

FIG. 3 is an exploded perspective view illustrating another example of a conventional torque limiter;

FIG. 4 is a cross-sectional view of the torque limiter of FIG. 3;

FIG. 5 is an assembled perspective view of a torque limiter according to an embodiment of the present invention;

FIG. 6 is an exploded perspective view of the torque limiter of FIG. 5; and

FIG. 7 is an assembled perspective view of a part of the torque limiter of FIG. 5.

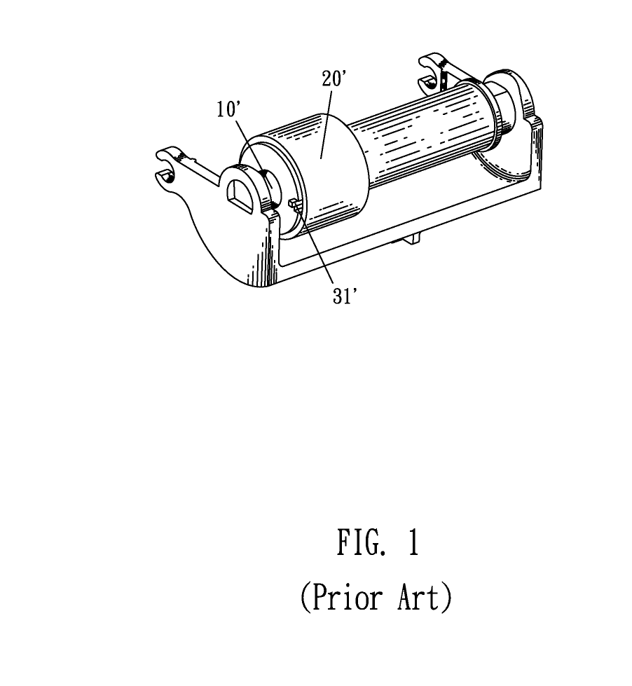

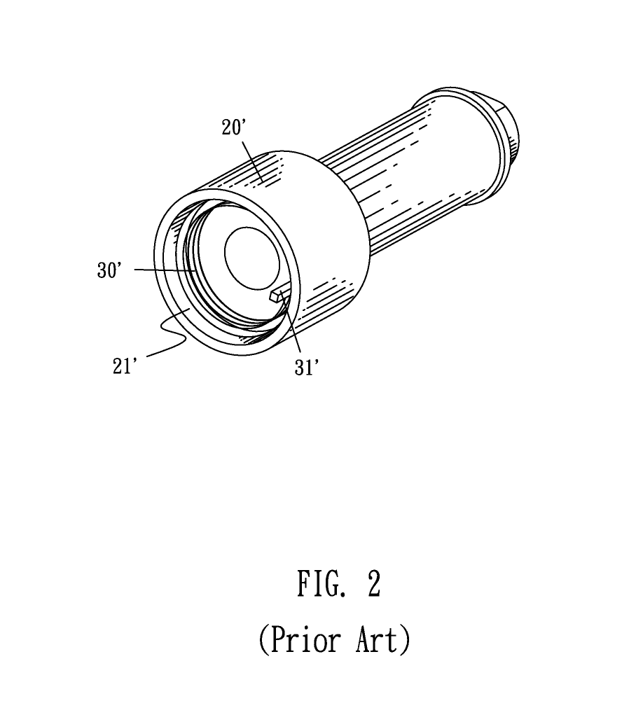

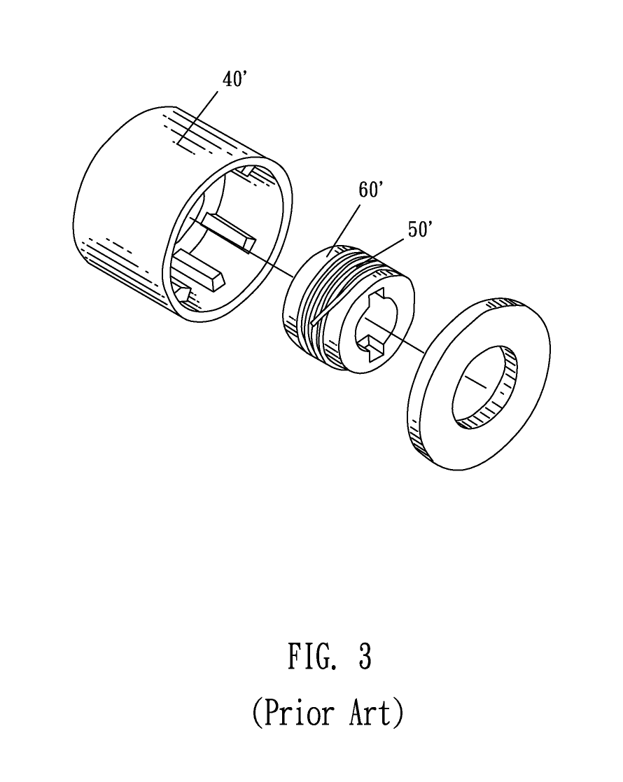

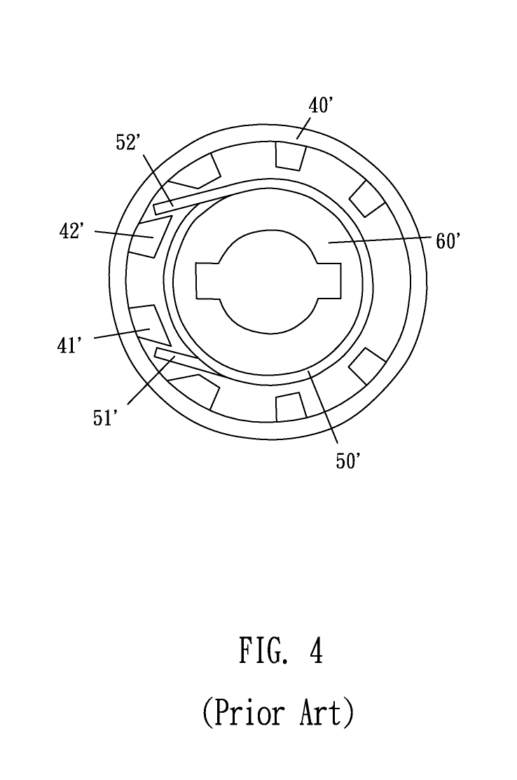

### DETAILED DESCRIPTION OF THE PREFERRED EMBODIMENT

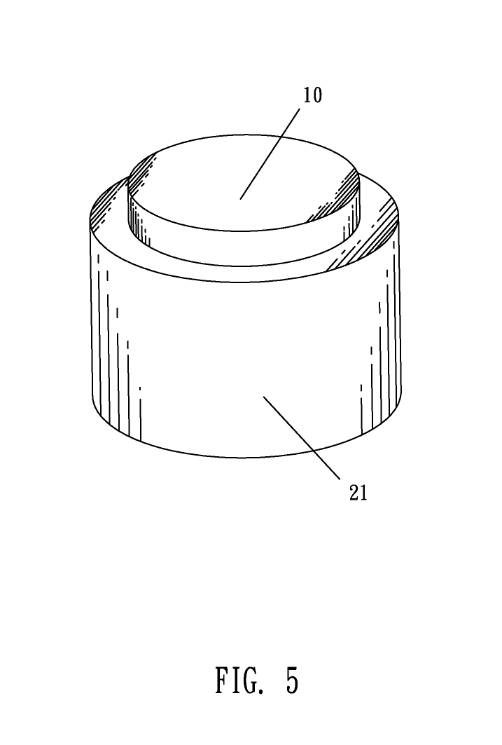

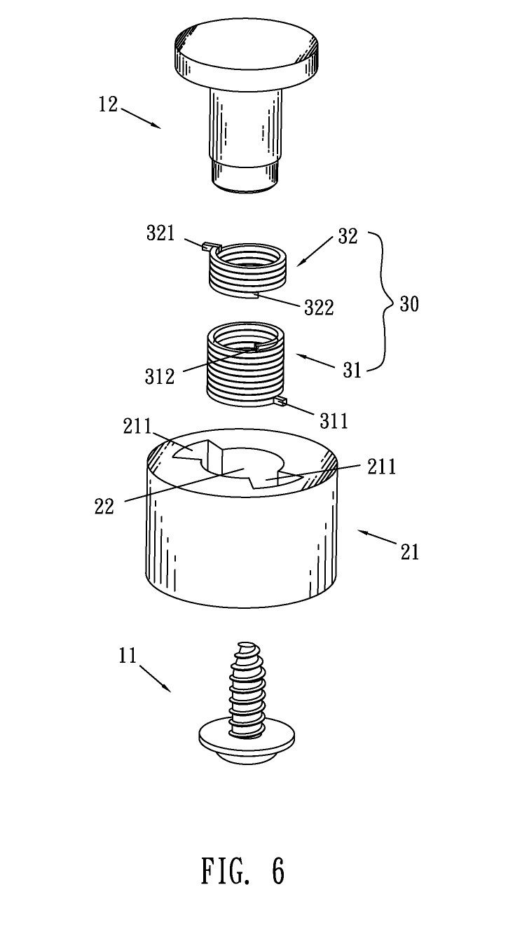

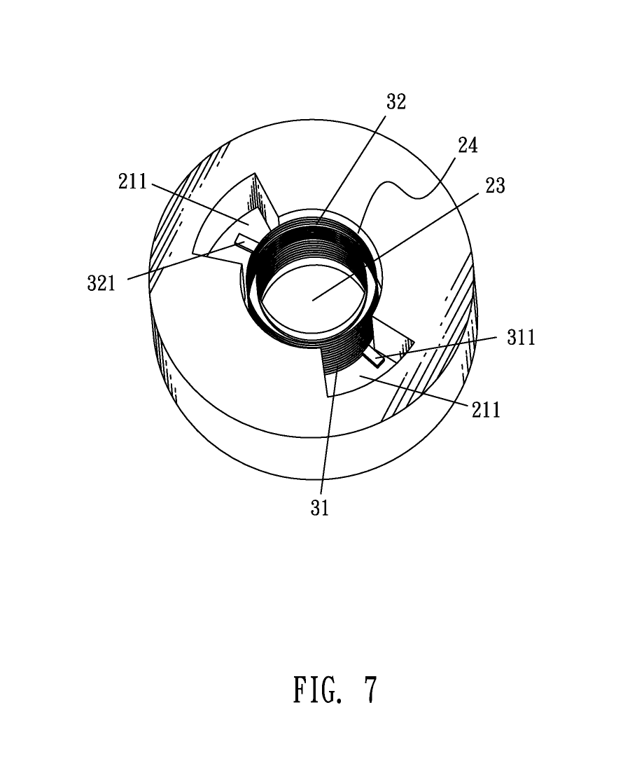

With reference to FIGS. 5-7, a torque limiter according to an embodiment of the present invention includes a fastening module 10, a driving part 21 and an elastic module 30.

The driving part 21 is of cylindrical shape, and defines a receiving chamber 22 which extends vertically to penetrate through a top face of the driving part 21 and is coaxial with the driving part 21. A bottom of the driving part 21 is opened with a through hole 23 coaxially communicated with the receiving chamber 22 and having a smaller diameter than that of the receiving chamber 22. An inner sidewall of the receiving chamber 22 is radially concaved outward to form at least two blocking grooves 211.

The fastening module 10 includes an axle part 12 and a fastening part 11. In this embodiment, the fastening part 11 is a fastening screw. The axle part 12 is inserted downward in the receiving chamber 22 of the driving part 21, and an outer circumference thereof is spaced from the inner sidewall of the receiving chamber 22 to form a cylindrical clearance 24 therebetween. A top end of the axle part 12 resists against the top face of the driving part 21. The fastening part 11 passes upward through the through hole 23 of the driving part 21 to fasten the axle part 12 and the fastening part 11 together, so as to make the fastening module 10 steadily assembled to the driving part 21 with the driving part 21 being rotatable relative to the fastening module 10.

The elastic module 30 includes a first elastic part 31 and a second elastic part 32 which are disposed in the clearance 24 and frictionally coupled to the outer circumference of the axle part 12. The first elastic part 31 has one distal end thereof protrude outward to form a first blocking portion 311, and the other distal end thereof designated as a first end portion 312. The second elastic part 32 has one distal end thereof protrude outward to form a second blocking portion 321, and the other distal end thereof designated as a second end portion 322. In assembly, the first end portion 312 of the first elastic part 31 resists against the second end portion 322 of the second elastic part 32, and the first blocking portion 311 and the second blocking portion 321 are located in the blocking grooves 211 of the driving part 21 respectively. In detail, when the first blocking portion 311 is against an inner sidewall of the corresponding blocking groove 211, the second blocking portion 321 is freely apart between two opposite inner sidewalls of the corresponding blocking groove 211; whereas, when the second blocking portion 321 is against an inner sidewall of the corresponding blocking groove 211, the first blocking portion 311 is freely apart between the two opposite inner sidewalls of the corresponding blocking groove 211. In this embodiment, the first elastic part 31 and the second elastic part 32 are different specifications of torsional springs.

In use, when the driving part 21 is rotated clockwise relative to the fastening module 10, the inner sidewall of one blocking groove 211 pushes against the first blocking portion 311 to make the first elastic part 31 rotate clockwise relative to the axle part 12. The rotation of the first elastic part 31 further drives the second elastic part 32 to rotate clockwise relative to the axle part 12 by way of the first end portion 312 pushing against the second end portion 322. So, a torque is produced by friction sliding between the inside diameter of the elastic module 30 and the outer circumference of the axle part 12. In detail, the friction sliding mainly occurs between the inside diameter of the first elastic part 31 and the outer circumference of the axle part 12.

When the driving part 21 is rotated counterclockwise relative to the fastening module 10, the inner sidewall of another blocking groove 211 pushes against the second blocking portion 321 to make the second elastic part 32 rotate counterclockwise relative to the axle part 12. The rotation of the second elastic part 32 further drives the first elastic part 31 to rotate counterclockwise relative to the axle part 12 by way of the second end portion 322 pushing against the first end portion 312. So, a torque is produced by friction sliding between the inside diameter of the elastic module 30 and the outer circumference of the axle part 12. In detail, the friction sliding mainly occurs between the inside diameter of the second elastic part 32 and the outer circumference of the axle part 12.

So, when the driving part 21 is rotated towards different directions, the torques produced by friction sliding are different on account of the different specifications of the torsional springs in this embodiment, and capable of being adjusted by changing wire diameter, number of turns and cross-section shape of the torsional springs etc.

As described above, the torque limiter in this invention utilizes the elastic module 30 (namely the two elastic parts 31, 32) and the cooperation design of the blocking grooves 211 and the blocking portions 311 and 321, to achieve the rotations in different directions and further realize different torques according to the rotations in the different directions and the specifications of the elastic parts 31, 32. So the torque limiter both is no limit to the rotation directions and can realize different torques with the different directions of rotations and changeable specifications of the elastic parts 31, 32.

What is claimed is:

1. A torque limiter, comprising:
a driving part defining a receiving chamber which extends vertically to penetrate through a top face of the driving part, an inner sidewall of the receiving chamber being radially concaved outward to form at least two blocking grooves;
a fastening module including an axle part which is inserted downward in the receiving chamber of the driving part, an outer circumference of the axle part being spaced from the inner sidewall of the receiving chamber to form a cylindrical clearance therebetween, the driving part being rotatable relative to the fastening module; and
an elastic module including a first elastic part and a second elastic part which are disposed in the clearance and frictionally coupled to the outer circumference of the axle part, the first elastic part having one distal end thereof protrude outward to form a first blocking portion and the other distal end thereof designated as a first end portion, the second elastic part having one distal end thereof protrude outward to form a second blocking portion and the other distal end thereof designated as a second end portion, the first end portion resisting against the second end portion and the first blocking portion and the second blocking portion being located in the blocking grooves of the driving part respectively;
wherein when the driving part is rotated clockwise relative to the fastening module, an inner sidewall of one blocking groove pushes against the first blocking portion to make the first elastic part rotate clockwise relative to the axle part and further drive the second elastic part to rotate clockwise by way of the first end portion pushing against the second end portion, so that produces a torque by friction sliding mainly between the first elastic part and the axle part; when the driving part is rotated counterclockwise relative to the fastening module, an inner sidewall of another blocking groove pushes against the second blocking portion to make the second elastic part rotate counterclockwise relative to the axle part and further drive the first elastic part to rotate counterclockwise by way of the second end portion pushing against the first end portion, so that produces a torque by friction sliding mainly between the second elastic part and the axle part.

2. The torque limiter as claimed in claim 1, wherein when the first blocking portion of the first elastic part is against the inner sidewall of the corresponding blocking groove of the driving part, the second blocking portion of the second elastic part is freely apart between two opposite inner sidewalls of the corresponding blocking groove; when the second blocking portion is against the inner sidewall of the corresponding blocking groove, the first blocking portion is freely apart between two opposite inner sidewalls of the corresponding blocking groove.

3. The torque limiter as claimed in claim 1, wherein the first elastic part and the second elastic part are torsional springs.

4. The torque limiter as claimed in claim 3, wherein the torsional springs have different specifications for making the torques different when the driving part is rotated towards different directions.

5. The torque limiter as claimed in claim 4, wherein the torques produced by friction sliding are capable of being adjusted by changing wire diameter, number of turns and cross-section shape of the torsional springs.

6. The torque limiter as claimed in claim 1, wherein a bottom of the driving part is opened with a through hole coaxially communicated with the receiving chamber and having a smaller diameter than that of the receiving chamber, the fastening module further includes a fastening part passing upward through the through hole of the driving part to fasten the axle part and the fastening part together, a top end of the axle part resists against the top face of the driving part.

7. The torque limiter as claimed in claim 6, wherein the fastening part is a fastening screw.
